(19) United States
(12) Patent Application Publication
(10) Pub. No.: US 2020/0249553 A1
(43) Pub. Date: Aug. 6, 2020

(54) PROJECTION APPARATUS

(71) Applicant: QISDA CORPORATION, Taoyuan City (TW)

(72) Inventors: Chi-Jen Chen, Taoyuan City (TW); Chih-Hsiang Wu, New Taipei City (TW); Kuo-Chun Lee, Taoyuan City (TW); Szu-Fan Chen, Taoyuan City (TW)

(21) Appl. No.: 16/737,921

(22) Filed: Jan. 9, 2020

(30) Foreign Application Priority Data
Jan. 31, 2019 (CN) 201910100086.8

(51) Int. Cl. G03B 21/14; G03B 21/20

(52) U.S. Cl. CPC G03B 21/145; G03B 21/2006

(57) ABSTRACT

A projection apparatus includes a solid-state light source module, a high-voltage power source, an image-forming-light generating module, an insulation ring and a projection lens module. The solid-state light source module has a solid-state light source and a first metal casing. The solid-state light source is disposed in the first metal casing. The high-voltage power source is electrically connected to the solid-state light source for providing electrical power to drive the solid-state light source to emit light. The image-forming-light generating module has a second metal casing. The insulation ring is connected to the first metal casing and the second metal casing for insulating the first metal casing from the second metal casing. The projection lens module is connected to the image-forming-light generating module for projecting an image generated by light emitted from the solid-state light source after the light enters the image-forming-light generating module through the insulation ring.

### BACKGROUND OF THE INVENTION

### 1. Field of the Invention

The present invention relates to a projection apparatus, and more specifically, to a projection apparatus utilizing an insulation ring to insulate a first metal casing of a solid-state light source from a second metal casing of an image-forming-light generating module.

### 2. Description of the Prior Art

With development of projection technology, a projector is widely used in a classroom, a meeting room, and home. In a conventional projector design utilizing a high-voltage power to drive a light source to generate a projection image, a voltage converter is usually used to convert power from a high voltage to a low voltage for providing a low-voltage power to an image-forming-light generating module of the projector. However, the aforesaid design causes the problem that related converter circuit components occupy much space in the projector so as to be disadvantageous to the thinning design of the projector. On the other hand, in another design directly utilizing a high-voltage power source rather than the voltage converter, it is hard to electrically insulate the light source from the image-forming-light generating module, so as to fail to meet the electrical requirements for the projector.

### SUMMARY OF THE INVENTION

The present invention provides a projection apparatus. The projection apparatus includes a solid-state light source module, a high-voltage power source, an image-forming-light generating module, an insulation ring, and a projection lens module. The solid-state light source module has a solid-state light source and a first metal casing. The solid-state light source is disposed in the first metal casing. The high-voltage power source is electrically connected to the solid-state light source for providing electrical power to drive the solid-state light source to emit light. The image-forming-light generating module has a second metal casing. The insulation ring is connected to the first metal casing and the second metal casing for insulating the first metal casing from the second metal casing. The projection lens module is connected to the image-forming-light generating module for projecting an image generated by light emitted from the solid-state light source after the light enters the image-forming-light generating module through the insulation ring.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a projection apparatus according to an embodiment of the present invention.

FIG. 2 is an exploded diagram of an insulation ring, a first metal casing, and a second metal casing in FIG. 1.

FIG. 3 is an assembly diagram of the insulation ring, the first metal casing, and the second metal casing in FIG. 2.

FIG. 4 is a diagram of an insulation ring being connected to the first metal casing and the second metal casing according to another embodiment of the present invention.

FIG. 5 is a cross-sectional diagram of the first metal casing and the second metal casing in FIG. 4 being fixed to the insulation ring along a cross-sectional line A-A.

FIG. 6 is a diagram of an insulation ring being connected to the first metal casing and the second metal casing according to another embodiment of the present invention.

FIG. 7 is a diagram of an insulation ring being connected to the first metal casing and the second metal casing according to another embodiment of the present invention.

### DETAILED DESCRIPTION

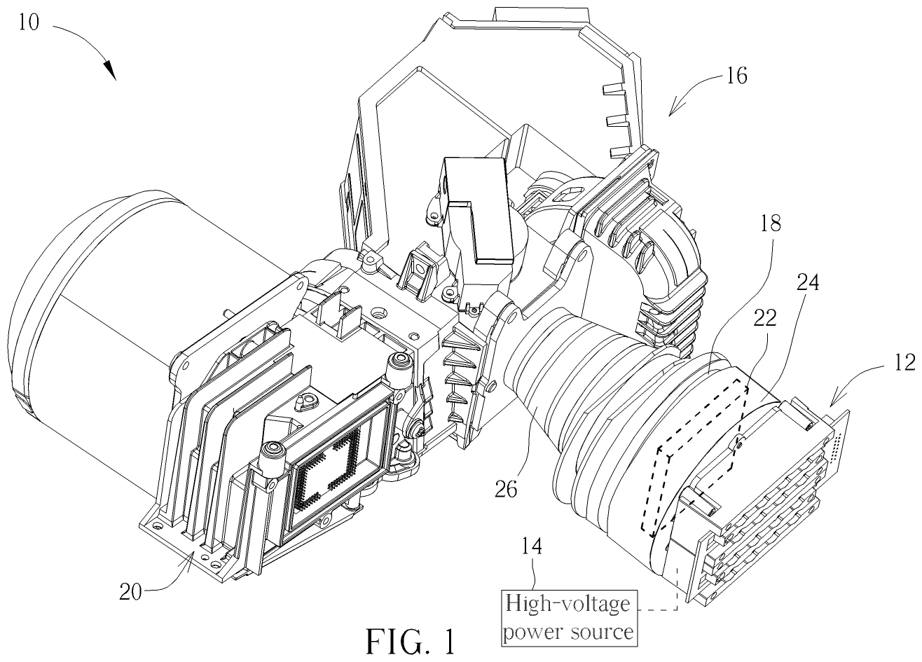

Please refer to FIG. 1, which is a diagram of a projection apparatus 10 according to an embodiment of the present invention. As shown in FIG. 1, the projection apparatus 10 could be preferably a solid-state light projector (e.g. a laser projector, but not limited thereto) and includes a solid-state light source module 12, a high-voltage power source 14 (briefly depicted as a functional block diagram in FIG. 1), an image-forming-light generating module 16, an insulation ring 18, and a projection lens module 20. The solid-state light source module 12 has a solid-state light source 22 (e.g. a laser light source briefly depicted by dotted lines in FIG. 1, but not limited thereto) and a first metal casing 24. The solid-state light source 22 is disposed in the first metal casing 24. The high-voltage power source 14 is electrically connected to the solid-state light source 22 for providing electrical power (e.g. 380V power, but not limited thereto) to drive the solid-state light source 22 to emit light. The image-forming-light generating module 16 could include optical components commonly used for forming image light of a solid-state light projector (e.g. a phosphor color wheel, a digital micromirror device (DMD), and a reflection mirror) and has a second metal casing 26. The projection lens module 20 is connected to the image-forming-light generating module 16 for projecting images generated by light emitted from the solid-state light source 22 after the light enters the image-forming-light generating module 16 through the insulation ring 18. As for the related description for the image forming principle and the configuration of the optical components, it is commonly seen in the prior art and omitted herein. Furthermore, the first metal casing 24 and the second metal casing 26 could be made of material commonly applied to a projector casing, such as magnesium-aluminum alloy material (but not limited thereto).

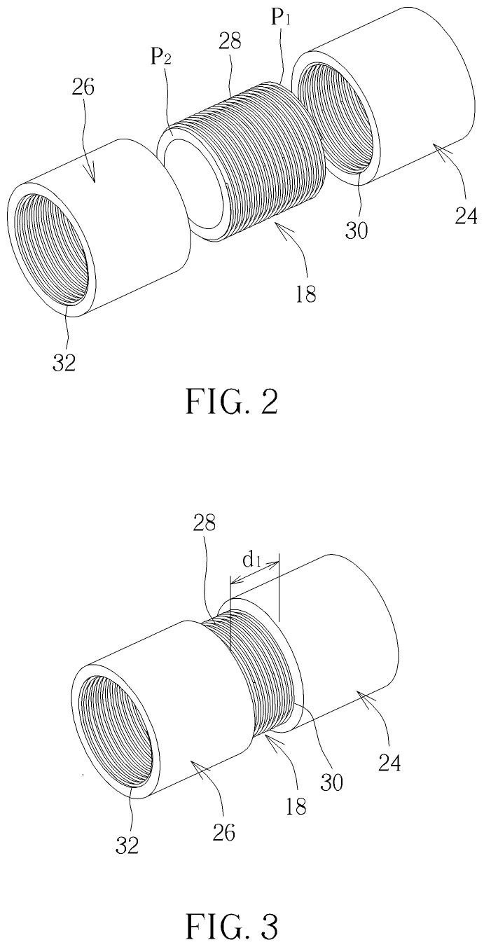

More detailed description for the connection design of the insulation ring 18, the first metal casing 24, and the second metal casing 26 is provided as follows. Please refer to FIG. 1, FIG. 2, and FIG. 3. FIG. 2 is an exploded diagram of the insulation ring 18, the first metal casing 24, and the second metal casing 26 in FIG. 1. FIG. 3 is an assembly diagram of the insulation ring 18, the first metal casing 24, and the second metal casing 26 in FIG. 2. For briefly showing the assembly design of the insulation ring 18, the first metal casing 24, and the second metal casing 26, the insulation ring 18, the first metal casing 24, and the second metal casing 26 are depicted as hollow cylindrical structures in FIGS. 2-3.

As shown in FIGS. 1-3, the insulation ring 18 is made of common insulation material (e.g. bakelite, mylar, ceramics, mica, silicone rubber, etc.), and the insulation ring 18 is connected to the first metal casing 24 and the second metal casing 26 to insulate the first metal casing 24 from the second metal casing 26. To be more specific, in this embodiment, a thread structure 28 could be formed on the insulation ring 18. A first screw hole 30 is formed on the first metal casing 24 corresponding to a first end P₁ of the thread structure 28. A second screw hole 32 is formed on the second metal casing 26 corresponding to a second end P₂ of the thread structure 28. Accordingly, the first screw hole 30 and the second screw hole 32 can be screwed on the thread structure respectively, so as to make the first metal casing 24 and the second metal casing 26 fixed to the insulation ring 18 and separate from each other for generating the electrical insulation effect. A distance d₁ between the first metal casing 24 and the second metal casing 26 could be preferably larger than or equal to 4 mm (but not limited thereto).

To be noted, the present invention could adopt the design in which the insulation ring sleeves the first metal casing and the second metal casing respectively in a screw-locking manner. In brief, in another embodiment, the thread structure is formed on the first metal casing and the second metal casing respectively, and the first screw hole and the second screw hole are formed on the insulation ring corresponding to the thread structures of the first metal casing and the second metal casing respectively. In such a manner, the first screw hole and the second screw hole of the insulation ring are screwed on the thread structures of the first metal casing and the second metal casing respectively, so as to make the first metal casing and the second metal casing fixed to the insulation ring and separate from each other for generating the electrical insulation effect.

Via the aforesaid high-voltage driving design directly utilizing the high-voltage power source rather than the voltage converter and the aforesaid insulation design utilizing the insulation ring to insulate the first metal casing and the second metal casing, the present invention can efficiently solve the prior art problem that the related converter circuit components occupy much space in the projector and it is hard to electrically insulate the light source from the image-forming-light generating module on a high voltage, so as to surely meet the electrical requirements for the projection apparatus 10. Thus, the present invention can improve electrical safety of the projection apparatus 10 and reduce the manufacturing cost of the projection apparatus 10. Moreover, since there is no need to additionally dispose a voltage converter in the projection apparatus 10, meaning the projection apparatus 10 does not need to perform the voltage converting operation, the present invention can further improve the power usage efficiency of the projection apparatus 10.

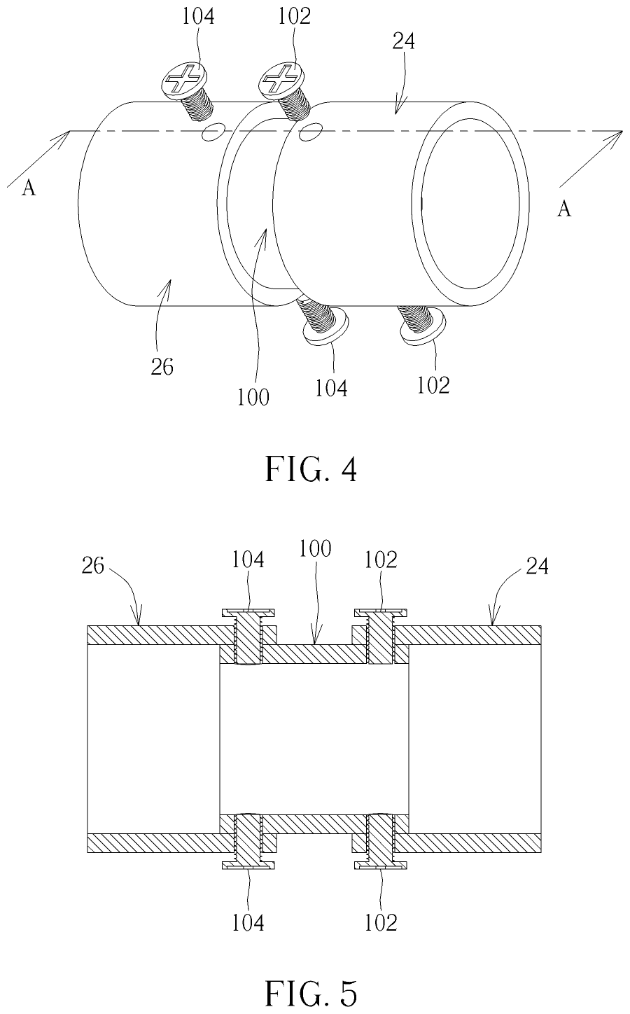

It should be mentioned that the design for connecting the first metal casing and the second metal casing via the insulation ring is not limited to the aforesaid embodiment. In other words, all the connection designs in which the insulation ring is utilized to connect the metal casing of the solid-state light source module and the metal casing of the image-forming-light generating module for generating the electrical insulation effect may fall within the scope of the present invention. For example, please refer to FIG. 4 and FIG. 5. FIG. 4 is a diagram of an insulation ring 100 being connected to the first metal casing 24 and the second metal casing 26 according to another embodiment of the present invention. FIG. 5 is a cross-sectional diagram of the first metal casing 24 and the second metal casing 26 in FIG. 4 being fixed to the insulation ring 100 along a cross-sectional line A-A. Components both mentioned in this embodiment and the aforesaid embodiment represent components with similar functions or structures, and the related description is omitted herein. Furthermore, for briefly showing the assembly design of the insulation ring 100, the first metal casing 24, and the second metal casing 26, the insulation ring 100, the first metal casing 24, and the second metal casing 26 are depicted as hollow cylindrical structures in FIG. 4.

As shown in FIG. 4 and FIG. 5, the insulation ring 100 is disposed through the first metal casing 24 and the second metal casing 26 respectively, at least one first screw 102 (two shown in FIGS. 4-5, but not limited thereto) is radially screwed into the first metal casing 24 and the insulation ring 100, and at least one second screw 104 (two shown in FIGS. 4-5, but not limited thereto) is radially screwed into the second metal casing 26 and the insulation ring 100. In such a manner, via radial screwing of the first screw 102 and the second screw 104, the first metal casing 24 and the second metal casing 26 can be fixed to the insulation ring 100 and separate from each other for generating the electrical insulation effect. To be noted, the present invention could adopt the design in which the insulation ring sleeves the first metal casing and the second metal casing in a radial screw-locking manner. In brief, in another embodiment, the insulation ring sleeves the first metal casing and the second metal casing respectively, the first screw is radially screwed into the insulation ring and the first metal casing to fix the insulation ring to the first metal casing, and the second screw is radially screwed into the insulation ring and the second metal casing to fix the insulation ring to the second metal casing. In such a manner, via radial screwing of the first screw and the second screw, the insulation ring can be fixed to the first metal casing and the second metal casing to make the first metal casing separate from the second metal casing for generating the electrical insulation effect.

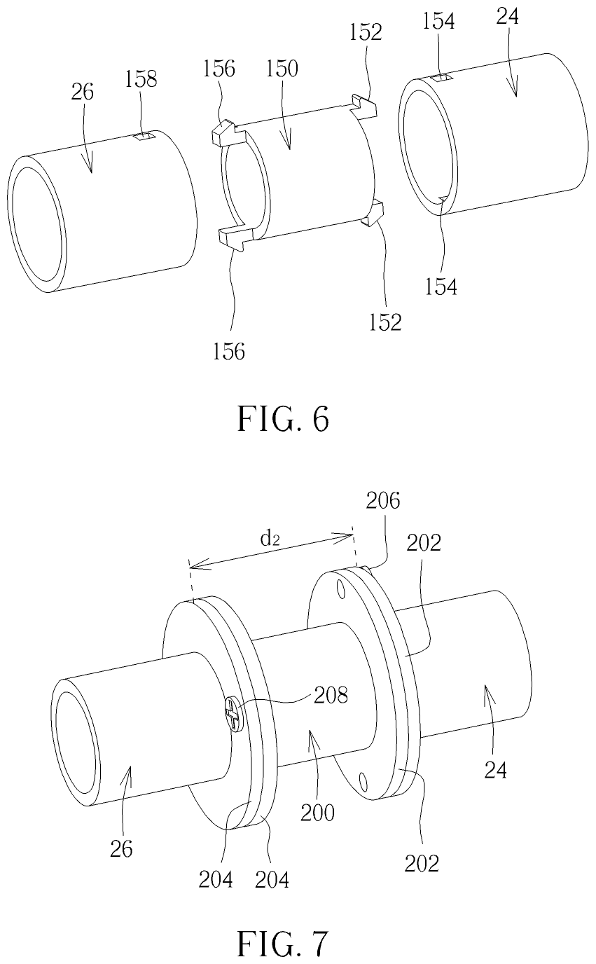

Furthermore, the present invention could adopt the design in which the insulation ring is connected to the first metal casing and the second metal casing in a structural engagement manner. For example, please refer to FIG. 6, which is a diagram of an insulation ring 150 being connected to the first metal casing 24 and the second metal casing 26 according to another embodiment of the present invention. Components both mentioned in this embodiment and the aforesaid embodiments represent components with similar functions or structures, and the related description is omitted herein. Furthermore, for briefly showing the assembly design of the insulation ring 150, the first metal casing 24, and the second metal casing 26, the insulation ring 150, the first metal casing 24, and the second metal casing 26 are depicted as hollow cylindrical structures in FIG. 6.

As shown in FIG. 6, at least one first hook 152 (two shown in FIG. 6, but not limited thereto) is formed on the insulation ring 150, a first engaging slot 154 is formed on the first metal casing 24 corresponding to the first hook 152, at least one second hook 156 (two shown in FIG. 6, but not limited thereto) is formed on the insulation ring 150, and a second engaging slot 158 is formed on the second metal casing 26 corresponding to the second hook 156. Accordingly, the first hook 152 could be engaged with the first engaging slot 154 to fix the first metal casing 24 to the insulation ring 150, and the second hook 156 could be engaged with the second engaging slot 158 to fix the second metal casing 26 to the insulation ring 150. In such a manner, via structural engagement of the first hook 152 and the first engaging slot 154 and structural engagement of the second hook 156 and the second engaging slot 158, the first metal casing 24 and the second metal casing 26 can be fixed to insulation ring 150 and separate from each other for generating the electrical insulation effect. To be noted, in another embodiment, the present invention could adopt the design in which the hooks are formed on the first metal casing and the second metal casing respectively and the corresponding engaging slots are formed on the insulation ring, and the related description could be reasoned by analogy according to the aforesaid embodiments and omitted herein.

Moreover, the present invention could adopt the design in which the insulation ring is connected to the first metal casing and the second metal casing in an axial screw-locking manner. For example, please refer to FIG. 7, which is a diagram of an insulation ring 200 being connected to the first metal casing 24 and the second metal casing 26 according to another embodiment of the present invention. Components both mentioned in this embodiment and the aforesaid embodiments represent components with similar functions or structures, and the related description is omitted herein. Furthermore, for briefly showing the assembly design of the insulation ring 200, the first metal casing 24, and the second metal casing 26, the insulation ring 200, the first metal casing 24, and the second metal casing 26 are depicted as hollow cylindrical structures in FIG. 7.

As shown in FIG. 7, two first skirt structures 202 are formed on the insulation ring 200 and the first metal casing 24 respectively, two second skirt structures 204 are formed on the insulation ring 200 and the second metal casing 26 respectively. At least one first screw 206 (one shown in FIG. 7, but not limited thereto) is axially screwed into the two first skirt structures 202 to fix the first metal casing 24 to the insulation ring 200. At least one second screw 208 (one shown in FIG. 7, but not limited thereto) is axially screwed into the two second skirt structures 204 to fix the second metal casing 26 to the insulation ring 200. The first screw 206 and the second screw 208 could be arranged alternately. A distance d₂ between the first screw 206 and the second screw 208 could be preferably larger than or equal to 4 mm, but not limited thereto. In such a manner, via the aforesaid design in which the first screw 206 is axially screwed into the two first skirt structures 202 and the second screw 208 is axially screwed into the two second skirt structures 204, the first metal casing 24 and the second metal casing 26 can be fixed to the insulation ring 200 and separate from each other for generating the electrical insulation effect.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection apparatus comprising:
a solid-state light source module having a solid-state light source and a first metal casing, the solid-state light source being disposed in the first metal casing;
a high-voltage power source electrically connected to the solid-state light source for providing electrical power to drive the solid-state light source to emit light;
an image-forming-light generating module having a second metal casing;
an insulation ring connected to the first metal casing and the second metal casing for insulating the first metal casing from the second metal casing; and
a projection lens module connected to the image-forming-light generating module for projecting an image generated by light emitted from the solid-state light source after the light enters the image-forming-light generating module through the insulation ring.

2. The projection apparatus of claim 1, wherein a thread structure is formed on the insulation ring, a first screw hole is formed on the first metal casing corresponding to a first end of the thread structure, a second screw hole is formed on the second metal casing corresponding to a second end of the thread structure, and the first screw hole and the second screw hole are screwed on the thread structure respectively, so as to make the first metal casing and the second metal casing screwed on the insulation ring and separate from each other.

3. The projection apparatus of claim 2, wherein a distance between the first metal casing and the second metal casing is larger than or equal to 4 mm.

4. The projection apparatus of claim 1, wherein the insulation ring sleeves the first metal casing and the second metal casing in a screw-locking manner.

5. The projection apparatus of claim 4, wherein a distance between the first metal casing and the second metal casing is larger than or equal to 4 mm.

6. The projection apparatus of claim 1, wherein the projection apparatus further comprises at least one first screw and at least one second screw, the insulation ring is disposed through the first metal casing and the second metal casing respectively, the at least one first screw is radially screwed into the first metal casing and the insulation ring to fix the first metal casing on the insulation ring, and the at least one second screw is radially screwed into the second metal casing and the insulation ring to fix the second metal casing on the insulation ring.

7. The projection apparatus of claim 6, wherein a distance between the first metal casing and the second metal casing is larger than or equal to 4 mm.

8. The projection apparatus of claim 1, wherein the projection apparatus further comprises at least one first screw and at least one second screw, the insulation ring sleeves the first metal casing and the second metal casing respectively, the at least one first screw is radially screwed into the insulation ring and the first metal casing to fix the insulation ring on the first metal casing, and the at least one second screw is radially screwed into the insulation ring and the second metal casing to fix the insulation ring on the second metal casing.

9. The projection apparatus of claim 8, wherein a distance between the first metal casing and the second metal casing is larger than or equal to 4 mm.

10. The projection apparatus of claim 1, wherein at least one first hook is formed on one of the insulation ring and the first metal casing, a first engaging slot is formed on the other one of the insulation ring and the first metal casing corresponding to the at least one first hook, the at least one first hook is engaged with the first engaging slot to fix the first metal casing to the insulation ring, at least one second hook is formed on one of the insulation ring and the second metal casing, a second engaging slot is formed on the other one of the insulation ring and the second metal casing corresponding to the at least one second hook, and the at least one second hook is engaged with the second engaging slot to fix the second metal casing to the insulation ring.

11. The projection apparatus of claim 10, wherein a distance between the first metal casing and the second metal casing is larger than or equal to 4 mm.

12. The projection apparatus of claim 1, wherein the projection apparatus further comprises at least one first screw and at least one second screw, two first skirt structures are formed on the insulation ring and the first metal casing respectively, two second skirt structures are formed on the insulation ring and the second metal casing respectively, the at least one first screw is screwed into the two second skirt structures to fix the second metal casing to the insulation ring, and the at least one second screw is screwed into the two first skirt structures to fix the first metal casing to the insulation ring.

13. The projection apparatus of claim 12, wherein a distance between the at least one first screw and the at least one second screw is larger than or equal to 4 mm.

14. The projection apparatus of claim 12, wherein the at least one first screw and the at least one second screw are alternately arranged.
